(19) United States
(12) Patent Application Publication
(10) Pub. No.: US 2025/0200882 A1
(43) Pub. Date: Jun. 19, 2025

(54) INFORMATION PROCESSING SYSTEM

(71) Applicant: NEC Communication Sytems, Ltd., Minato-ku, Tokyo (JP)

(72) Inventors: Yuri ADACHI, Tokyo (JP); Masanori Takaoka, Tokyo (JP); Satoki Ueno, Tokyo (JP); Noriyuki Aoki, Tokyo (JP); Kenji Kono, Tokyo (JP)

(73) Assignee: NEC Communication Sytems, Ltd., Minato-ku, Tokyo (JP)

(21) Appl. No.: 18/847,842

(22) PCT Filed: Mar. 15, 2023
(86) PCT No.: PCT/JP2023/010104

§ 371 Date: Sep. 17, 2024

(30) Foreign Application Priority Data
Mar. 28, 2022 (JP) 2022-051679

(51) Int. Cl. G06T 17/00

(52) U.S. Cl. CPC G06T 17/005

(57) ABSTRACT

An information processing system includes a plurality of user terminals and a server device connected with the user terminals, and allows the user terminals to share virtual space information. The information processing system also includes a database having a layer structure configured of layers for respective types of virtual space information, and configured to store the virtual space information in the layer structure. The server device is configured to, for each of the user terminals, extract virtual space information necessary for the user of the user terminal from the database, and transmit the virtual space information to the user terminal.

### TECHNICAL FIELD

The present invention relates to an information processing system, an information processing method, a server device, and a storage medium.

### BACKGROUND ART

A system for sharing a virtual space among a plurality of user terminals has been proposed (for example, Patent Literatures 1 and 2).

### CITATION LIST

### Patent Literature

Patent Literature 1: JP 2001-249876 A
Patent Literature 2: JP 2003-108793 A

### SUMMARY OF INVENTION

### Technical Problem

In order to realize smooth communication among users in a virtual space, it is necessary to enable extraction of information of the virtual space necessary for the user terminals from virtual space information in real time and sharing of the information among user terminals. However, an effective system for extracting information of a virtual space necessary for a plurality of user terminals from virtual space information in real time and sharing the information among them has not been proposed currently, even in Patent Literatures 1 and 2.

An object of the present invention is to provide a information processing system that solves the problem described above.

### Solution to Problem

An information processing system according to one aspect of the present invention is an information processing system including a plurality of user terminals and a server device connected with the user terminals, and allowing the user terminals to share virtual space information.

The information processing system further includes
a database having a layer structure including layers for the respective types of the virtual space information and configured to store the virtual space information in the layer structure.
the server device is configured to, for each of the user terminals, extract virtual space information necessary for a user of the user terminal from the database, and transmit the virtual space information to the user terminal.

A server device according to another aspect of the present invention is
a server device in an information processing system including a plurality of user terminals and the server device connected with the user terminals and allowing the user terminals to share virtual space information.

The server device includes
a database having a layer structure including layers for the respective types of the virtual space information, and configured to store the virtual space information in the layer structure. The server device is configured to, for each of the user terminals, extract virtual space information necessary for a user of the user terminal from the database, and transmit the virtual space information to the user terminal.

An information processing method according to another aspect of the present invention is
an information processing method to be executed by a server device in an information processing system, the information processing system including a plurality of user terminals and the server device connected with the user terminals and allowing the user terminals to share virtual space information.

The method is configured to,
from a virtual space information database having a layer structure including layers for the respective types of the virtual space information and configured to store the virtual space information in the layer structure, for each of the user terminals, extract virtual space information necessary for a user of the user terminal, and transmit the virtual space information to the user terminal.

A computer-readable medium according to another aspect of the present invention is configured to store thereon a program for causing a computer constituting a server device in an information processing system to execute processing to, the information processing system including a plurality of user terminals and the server device connected with the user terminals and allowing the user terminals to share virtual space information,
from a virtual space information database having a layer structure including layers for the respective types of the virtual space information and configured to store the virtual space information in the layer structure, for each of the user terminals, extract virtual space information necessary for a user of the user terminal, and transmit the virtual space information to the user terminal.

### Advantageous Effects of Invention

With the configurations described above, the present invention enables extraction of virtual space information necessary for user terminals from the virtual space information in real time and sharing of the information among the user terminals.

### BRIEF DESCRIPTION OF DRAWINGS

FIG. 1 illustrates an example of virtual space information shared among a paramedic and doctors according to a third example embodiment of the present invention.

FIG. 2 illustrates an example of virtual space information shared between a paramedic and doctors according to the third example embodiment of the present invention.

FIG. 3 illustrates an example of a layer structure for extraction, retrieval, expression, and management of data according to the third example embodiment of the present embodiment.

FIG. 4 illustrates an example of main operation according to the third example embodiment of the present invention.

FIG. 5 illustrates a configuration example of an information processing system according to the third example embodiment of the present invention.

FIG. 6 illustrates a logical configuration example of a server device according to the third example embodiment of the present invention

FIG. 7 is a schematic diagram illustrating a structure of extracting only data necessary for the user of a user terminal from virtual space information according to the third example embodiment of the present invention.

FIG. 8 illustrates a logical configuration example of a user terminal according to the third example embodiment of the present invention.

FIG. 9 is a flowchart illustrating an example of processing performed by the server device according to the third example embodiment of the present invention.

FIG. 10 is a flowchart illustrating an example of processing performed by a user terminal according to the third example embodiment of the present invention.

FIG. 11 is a flowchart illustrating an example of operation of the information processing system according to the third example embodiment of the present invention.

FIG. 12 is a schematic diagram illustrating an example of virtual space information shared among station staff members according to a fourth example embodiment of the present invention.

FIG. 13 illustrates an example of a structure of data extraction according to the fourth example embodiment of the present invention.

FIG. 14 is a schematic diagram illustrating an example of virtual space information shared among a delivery person manager and delivery persons according to a fifth example embodiment of the present invention.

FIG. 15 illustrates an example of a structure of data extraction according to the fifth example embodiment of the present invention.

FIG. 16 is a schematic diagram illustrating an example of virtual space information shared among a manager and workers according to a sixth example embodiment of the present invention.

FIG. 17 illustrates an example of a structure of data extraction according to the sixth example embodiment of the present invention.

FIG. 18 is a schematic diagram illustrating an example of virtual space information shared among workers according to a seventh example embodiment of the present invention.

FIG. 19 illustrates an example of a structure of data extraction according to the seventh example embodiment of the present invention.

FIG. 20 is a block diagram according to a first example embodiment of the present invention.

### DESCRIPTION OF EMBODIMENTS

Next, example embodiments of the present invention will be described in detail with reference to the drawings.

### First Example Embodiment

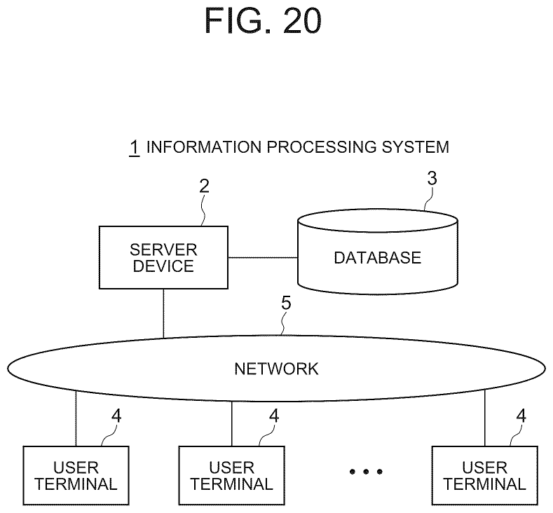

FIG. 20 is a block diagram of an information processing system according to a first example embodiment of the present invention. Referring to FIG. 20, an information processing system 1 according to the present embodiment is configured to include a server device 2, a database 3 connected thereto, and a plurality of user terminals 4 connected to the server device 2 over a network 5 such as the Internet. The server device 2 and the database 3 may be provided in the same enclosure, or may be connected to each other over a network such as the Internet. The server device 2 and the database 3 may be a virtual server and a virtual database on the cloud, or may be a real server and a real database.

The database 3 is a storage device that stores therein various types of virtual space information. The virtual space information to be stored includes, for example, data of three-dimensional buildings, roads, and the like, mobile body data of characters (avatars), persons, animals, cars, and the like, data related to communication such as chat created by the user of a user terminal, data related to road traffic information, data related to climate such as weather forecast, data measured by sensors such as an acceleration sensor, a temperature sensor, a pressure sensor, and the like. However, the virtual space information to be stored in the database 3 is not limited to those described above, and may be any information if it can be placed in the virtual space.

The database 3 has a layer structure configured of layers of respective types of virtual space information. The database 3 is configured to be able to record and read virtual space information on and from each layer. The types and the number of units of virtual space information to be stored in the database 3 and the types and the number of layers are arbitral. Examples of layers include a layer related to persons, a layer related to a space, a layer related to time, a layer related to communication, and the like. Other examples of layers include a layer for each organization to which the user of the user terminal 4 belongs, a layer for each business type, a layer for each work, a layer for each role, and the like. One layer may be divided into a plurality of layers. For example, a layer for storing a type of information may be divided into a plurality of layers corresponding to the granularity of information to be stored. Alternatively, a layer for storing a type of information may be divided into a plurality of layers corresponding to the freshness of information to be stored. In addition, any layers can overlap each other. Overlapping a plurality of layers is a method of multiplexing the layers. A multiplexed layer structure has virtual space information in which pieces of virtual space information stored in the respective layers are combined. A plurality of multiplexed layer structures in which overlapping layers differ from each other store units of virtual space information different from each other (a variety of units of virtual space information). The users of a plurality of user terminals can share virtual space information in each layer unit, and also can share virtual space information in each multiplexed layer structure unit.

In the database 3, units of virtual space information related to each other between layers are associated with each other by a tree structure, a graph structure, or a network structure. Associating a plurality of layers with each other by a tree structure or the like is another method of multiplexing the layers. The types of virtual space information associated with each other by a tree structure or the like, and the types of layers storing them are arbitral. For example, data x1 stored on a layer corresponding to an organization X1 to which a user U1 of a user terminal 4 and data y2 stored on a layer corresponding to a role Y2 of a user U2 of another user terminal 4 belonging to another organization X2 may be associated with each other by a tree structure. With such association, it is possible to efficiently retrieve or extract necessary virtual space information between users belonging to different organization. While the example described above is sharing of virtual space information between different organizations, it is of course possible to utilize association by the tree structure of the like for sharing virtual space information among different business types, works, and roles.

The server device 2 is configured to include a processor that performs arithmetic processing such as a central processing unit (CPU), various storage devices such as a main storage, hardware such as a wired or wireless communication device, and software such as a program to be executed on the processor. The user terminal 4 is an electronic device such as a personal computer or a smartphone, and is configured to include a processor that performs arithmetic processing such as a central processing unit (CPU), storage devices such as a main storage and an auxiliary storage for storing data and a program, a display device that displays a virtual space or the like, and an input device for performing input operation.

The server device 2 is configured to, for each user terminal 4, extract virtual space information necessary for the user of the user terminal 4 from the database 3, and transmit it to the user terminal 4 over the network 5. For example, for each user terminal 4, the server device 2 stores therein information defining the organization to which the user belongs, business type, work, and role of the user. The server device 2 refers to the definition information to recognize the organization to which the user belongs, the business type, the work, and the role of the user, and extracts virtual space information stored on the layer corresponding thereto from the database 3 as virtual space information necessary for the user. The virtual space information is stored on a layer of the database 3 by type. Therefore, the server device 2 can efficiently extract virtual space information stored in the layer corresponding to the organization to which the user belongs, the business type, the work, and the role of the user, from the database 3. Moreover, since it is not necessary to extract every virtual space information stored in the database 3, the processing load on the server device 2 can be reduced. As a result, even the enormous virtual space information can be shared by a plurality of user terminals on a real-time basis.

In addition, the server device 2 retrieves or extracts virtual space information of another layer associated with the extracted virtual space information by the tree structure or the like as virtual space information necessary for the user, from the database 3. As a result, the server device 2 can efficiently retrieve or extract necessary virtual space information between users belonging to different organizations, business types, works, and roles.

The user terminal 4 is configured to display a virtual space on a display device on the basis of the virtual space information received from the server device 2. As described above, only virtual space information of the type necessary for the user of the user terminal 4 is delivered from the server device 2 to the user terminal 4. Therefore, even the user terminal 4 in which the storage capacity and the processing speed are low can display the necessary virtual space on a display device comfortably, so that it is possible to easily secure the real-time property.

Moreover, the user terminal 4 can perform processing such as acquisition of data in the virtual space, creation of new data, update, deletion, and the like by the user operation (operation via an input device) performed on the virtual space displayed on the display device. For example, the user terminal 4 operates to move the own avatar in the virtual space according to the user operation, to make communication with an avatar of another user by chat or the like. After processing the virtual space information according to the user operation, the user terminal 4 transmits the virtual space information, that is, an operation result, to the server device 2.

The server device 2 stores the virtual space information received from the user terminal 4 on a layer of the database 3 corresponding to the type. The server device 2 also associates the virtual space information newly stored in the database 3 with virtual space information related thereto and having been stored on another layer with each other by a tree structure or the like. In addition, for the virtual space information newly stored in the database 3, the server device 2 determines, for each user terminal 4, whether or not it is virtual space information necessary for the user thereof on the basis of the organization to which the user belongs, the business type, the work, and the role of the user, or/and presence of absence of association in the tree structure or the like. Then, the server device 2 delivers the virtual space information to the user terminal 4 of the user for whom the newly stored virtual space information is necessary.

As described above, the information processing system 1 according to the present invention has a layer structure configured of layers for respective types of virtual space information, includes the database 3 configured to store the virtual space information in the layer structure, and the server device 2 is configured to, for each user terminal 4, extract virtual space information necessary for the user of the user terminal 4 from the database 3 and transmit it to the user terminal 4. Therefore, the server device 2 can efficiently retrieve or extract virtual space information necessary for the user of the user terminal 4 from the database 3, and transmit it to the user terminal 4. As a result, even though enormous virtual space information is stored in the database 3, it is possible to easily share virtual space information among a plurality of user terminals 4 on a real-time basis.

Further, the database 3 of the information processing system 1 according to the present embodiment is configured to associate units of virtual space information that are related to each other and stored in a plurality of layers, with each other by a tree structure, a graph structure, or a network structure. Therefore, the server device 2 can retrieve or extract virtual space information necessary for the user of the user terminal 4 from the database 3 more efficiently. In particular, in the case of adopting a configuration in which related units of virtual space information, among units of virtual space information stored on a plurality of layers whose organizations, business types, works, and roles are different from each other in the database 3, are associated with each other by a tree structure or the like, the server device 2 can efficiently retrieve or extract necessary virtual space information between organizations, business types, works, roles that are different from each other, from the database 3. As a result, even the enormous virtual space information can be shared by a plurality of user terminals whose organizations, business types, works, and roles are different from each other, on a real-time basis.

### Second Example Embodiment

Next, a second example embodiment of the present invention will be described.

Conventionally, in the case of communicating with people remotely for tasks such as

inspection, monitoring, maintenance, and operation, text such as email or chat or voice calls such as telephone is used. Further, for sharing data remotely, data is summarized by using spreadsheet software or word processing software and is shared using the cloud. However, such a method causes a time lag. Therefore, it is difficult to share information in real time and make communication. Moreover, it is difficult to understand and inform the situation of the site only by exchanging information of text and photos. Therefore, a communication system for remotely sharing data efficiently on a real-time basis, which is easy to use for users, is required. The present embodiment is an information processing system that achieves such an object.

An information processing system according to the present embodiment constructs a virtual space simulating the real world on the Internet or a computer system to efficiently share information in real time, for tasks such as inspection, monitoring, maintenance and operation. Moreover, the present information processing system is configured to use avatars or the like to easily show the current location information, actions, and conditions of the workers so as to allow them to make communication in the virtual space.

Moreover, in the present information processing system, since large-volume virtual space information such as 3D data is shared in real time, the virtual space information configured of time information, location information, and other types of information is managed in a multiplexed manner by a layer structure or a tree structure in the database of a server device. As a result, the server device can update the virtual space information efficiently on a real-time basis. Furthermore, in order to share large-volume data such as 3D data efficiently (only necessary information, related information, and useful information efficiently) among a plurality of users, the server device is configured to efficiently extract only data necessary for each user from the virtual space information managed in a multiplexed manner by a layer structure or a tree structure in the database, and present it to each user.

According to the information processing system of the present embodiment, it is possible to share information and make communication efficiently in real time among administrators and operators for performing tasks such as inspection and monitoring for example, in the virtual space simulating the real work (not necessarily simulating the real). By entering a virtual three-dimensional space constructed on the Internet using the own avatar or the like and making communication with others in the virtual space by using avatars or the like (not necessarily using avatars) rather than conventional telephone, email, chat, or the like, it is possible to contact in real time even in the case of a large site. For example, in the present information processing system, since large-volume data such as 3D data is shared among the users of a plurality of user terminals in real time, data of time information, location information, and other types of information is managed in a multiplexed manner by a layer structure or a tree structure in the database connected to the server device. As a result, the virtual space information can be shared efficiently in real time among a plurality of users. Moreover, shared or created information can be shared efficiently according to the organizations to which the users belong, and tasks and roles of the various users. For example, in order to share large-volume data such as 3D data efficiently (only necessary information, related information, and useful information efficiently), the server device can efficiently extract data necessary for each user from the information managed in a multiplexed manner by a layer structure or a tree structure in the database, and present it to each user.

The database stores therein and manages virtual space information in a multiplexed manner in a layer structure for each organization, or each business type, task, or role of the user, for example. By adjusting the granularity of information for each layer in the database and extracting and integrating information in the server device. it is possible to reduce the processing load and to secure the real time property. Since it has a layer structure, it is possible to switch show/hide for each layer, and to reduce the processing load on the user terminal of the user and improve the real time property. Further, in the viewpoint of system construction and developers, when there is a bug anywhere, the problem may be solved by checking only the layer, which contributes to efficient development. This means that since it is not closely connected, those who perform system construction and development can perform inspection, verification, and test for each layer.

Since information is categorized by the layer structure, it is easy to manage virtual space information (insertion, extraction, change, update, and the like). Further, related information stored in the layers are connected by the tree structure, the server device can retrieve or extract relationship of information and its temporal relationship, so that the server device can easily retrieve necessary information. Therefore, the server device can extract or select only information important for the user. Moreover, since the relation of granularity direction is also managed by the tree structure, the server device can access necessary information quickly when it desires to know more detailed information of the location from the rough content about the location (granularity control can be made). Moreover, since layers are related to each other in the tree structure, the server device can extract not only information of one layer but also information related to a number of pieces of related information together, and display them on the user terminal. Furthermore, since pieces of information are associated with each other in the tree structure in the time direction, the server device can retrieve the record efficiently, and can retrieve the time direction and the related direction of the information simultaneously. In addition, since it is possible to multiplex information (spaces) by making links of information in another space in the database, it is possible to fill a limited space with a large amount of pieces of information without gaps.

### Third Example Embodiment

Next, a third example embodiment of the present invention will be described. The present embodiment is an example of applying the present invention to emergency transport.

In an emergency transport site, a paramedic directly makes calls to emergency hospitals or the like in the ambulance to find a hospital capable of accepting the patient. At that time, comprehensive determination is made by the paramedic or the hospital on the basis of the distance from the location of the patient to the hospital, specialties and the number of doctors on call, and the number of hospital beds. Therefore, there is a case where it is hard to find a transport destination and the patient is sent around. This causes a problem that is it difficult to quickly transport a patient to a hospital.

In view of the above, the information processing system according to the present embodiment is not a system for finding a hospital that can accept the patient exhaustively by phone like a conventional system, but a system that shows the real town or schematically or abstractly shows the real town in a virtual space and reflects paramedics and doctors of hospitals as avatars or the like in the virtual space. Accordingly, the present information processing system enables sharing of information from other systems such as patient information, possibility status of acceptance of patient in the hospital, and traffic information on a real-time basis, among a plurality of users of user terminals, so as to allow the paramedics and the doctors to make smooth communication.

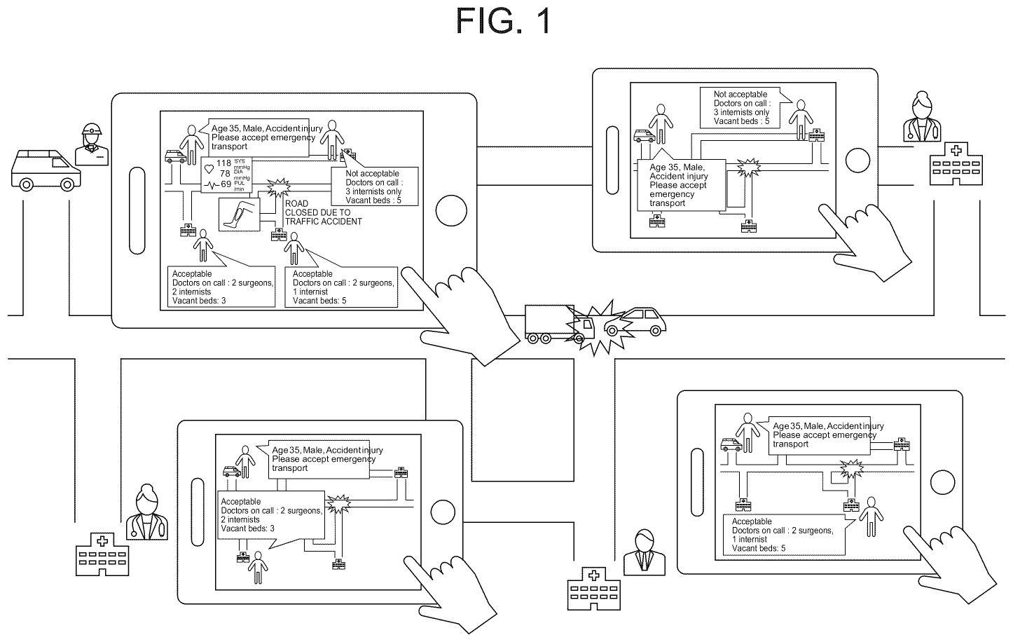

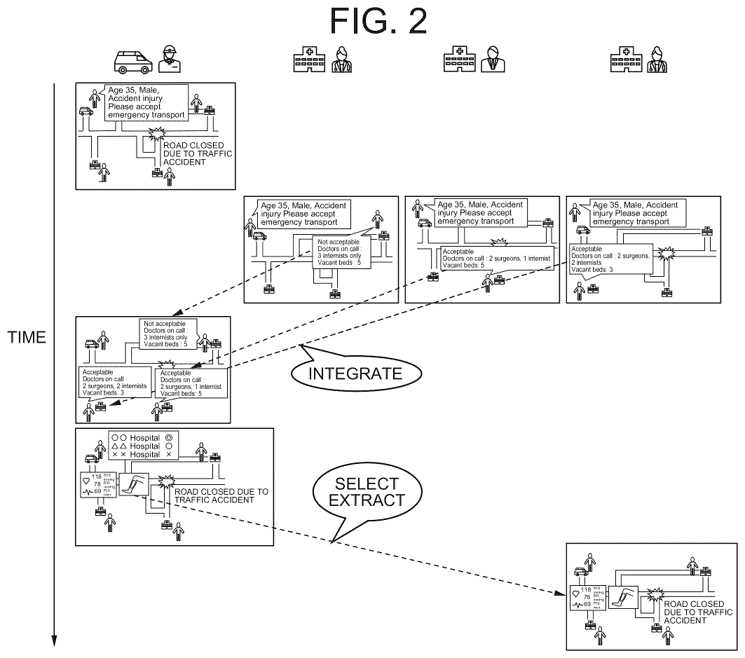

FIGS. 1 and 2 illustrate an example of virtual space information shared among paramedics and the doctors in the present information processing system. In this example, there are one paramedic and three doctors. These four users share the virtual space information including map information, road traffic information, user location information, and the like. When a paramedic operates the own avatar existing in the virtual space shown on the user terminal to send a message “Age 35, Male, Accident injury, Please accept emergency transport”, a server device that received this message displays the message on the user terminal of a doctor of a hospital near the location of the paramedic. The server device also extracts information related to the hospitals to which the respective doctors belong from the database, and displays the message on the user terminals of respective doctors. For example, as information related to hospitals, the number of doctors capable of coping, the specialties of the doctors, the number of hospital beds, and the like are shown as examples. Each doctor decides acceptance/non-acceptance on the basis of the displayed information, and operates the own avatar shown on the user terminal to send a reply message to the paramedic. For example, in the examples of FIGS. 1 and 2, messages such as “Not acceptable, Doctors on call: 3 internists only, Vacant beds: 5”, “Acceptable, Doctors on call: 2 surgeons, 2 internists, Vacant beds: 3”, “Acceptable, Doctors on call: 2 surgeons, 1 internist, Vacant beds: 5” are transmitted from the doctors. The server device integrates these messages, and transmit them to the user terminal of the paramedic. The paramedic recognizes the messages from the nearby doctors displayed on the own user terminal, and decides a transport destination hospital. Then, when the paramedic operates to select the transport destination hospital, the information is transmitted from the user terminal to the server device. At that time, when there are sensor information such as heart rate and blood pressure of the patient and images of the injury part, they are also transmitted from the user terminal to the server device. The server device transmits patient information and the like received from the user terminal of the paramedic, to the user terminal of a doctor of the hospital determined to be the transport destination. As a result, the doctor of the hospital determined to be the transport destination can understand the patient condition and the like in advance.

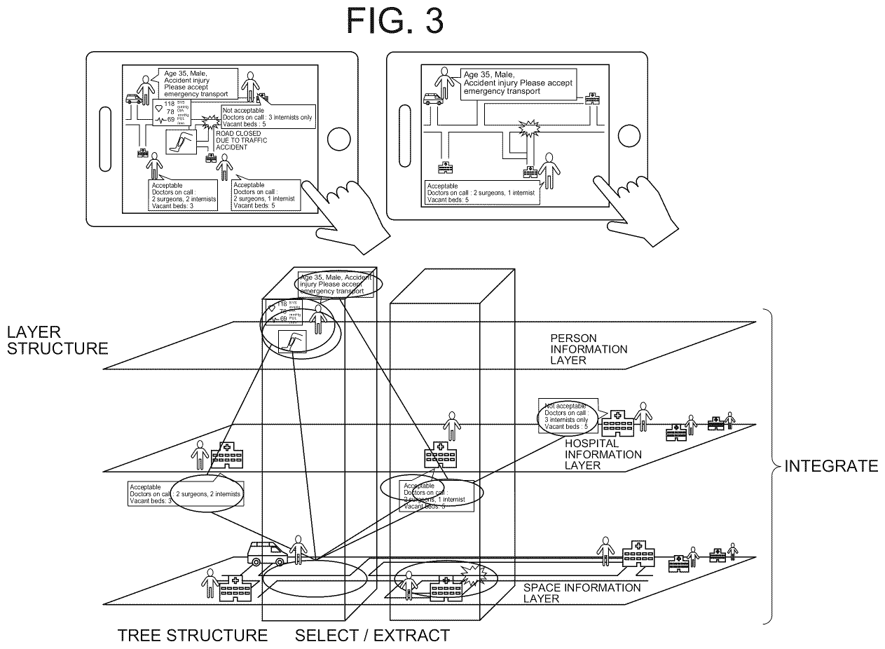

FIG. 3 illustrates an example of a layer structure for extraction, retrieval, expression, and management of data in the emergency transport of the present embodiment. Referring to FIG. 3, a database for storing virtual space information in the present embodiment is configured of various layers such as a person information layer including medical information and the like, a hospital information layer including the number and specialties of doctors capable of handling, the number of hospital beds, and the like of each hospital, a space information layer including map, location information of users, traffic information, and the like, a layer of information from other systems, and a time layer enabling confirmation of past records, and the virtual space information is multiplexed. As described above, the virtual space information is integrated as a layer structure, and it is possible to adjust the granularity (information granularity, space granularity, time granularity, and the like) of each layer. Moreover, the layers are linked by a tree structure or a graph structure (network structure or the like), so that data necessary for each user terminal can be selected or extracted. Furthermore, a user can add any virtual layers, virtual information, and virtual structures to the existing virtual space (another virtual space may be created (multiplexed)). For example, at the time of a disaster, when a remote doctor or an AI doctor (artificial intelligence system like chatbot or the like) not existing in the real space and geographical site is placed in the virtual space in the user terminals, the paramedics at the disaster site can perform the most appropriate first aid by being instructed by a doctor in the virtual space.

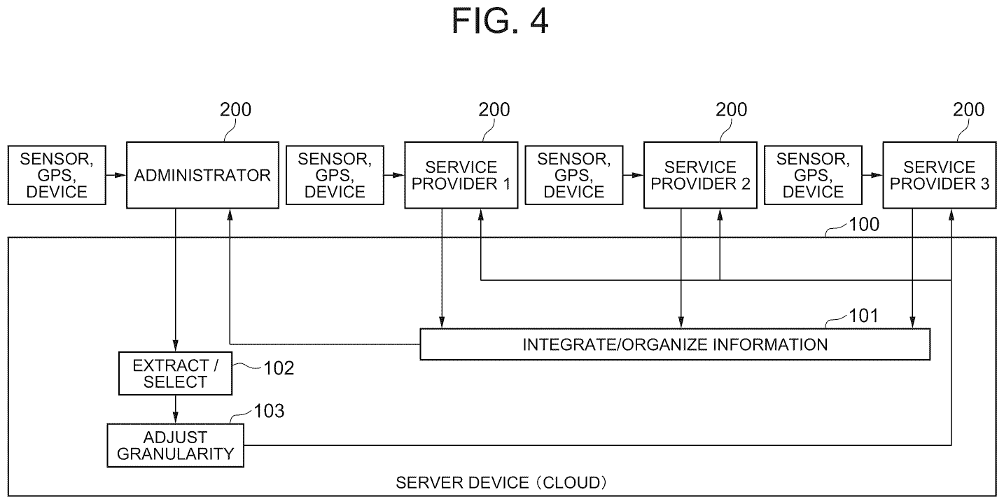

FIG. 4 illustrates examples of main operations in the information processing system according to the present embodiment. In each of user terminals (user terminals of various types of service providers (organizations, groups, and the like)) 200, for example, an operation to collect sensor information acquired from cameras, 3D sensors, and the like, location information acquired from a GPS or the like, and measurement information and condition information acquired from some equipment, facilities, devices, and the like is performed. In the server device 100, an operation to receive the collected information, integrate it by a space information integration unit 114 to be described below (101), and deliver the integrated virtual space information to the user terminal 200, is performed. Further, in the server device 100, an operation to extract or select the collected information (102), an operation to adjust the granularity of the extracted or selected virtual space information (103), and an operation to deliver the adjusted virtual space information to the user terminal 200 are performed.

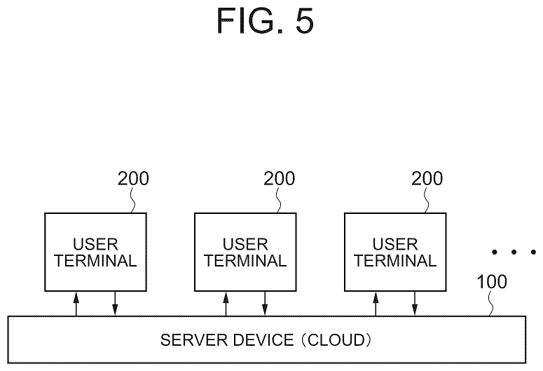

FIG. 5 illustrates a configuration example of the information processing system according to the present embodiment. The user terminal 200 shares virtual space information with another user terminal 200 in real time via the server device 100. The server device 100 may be a virtual server on the cloud or a real server. The user terminal 200 is a personal computer, a tablet, a smartphone, a glass-type device that realizes virtual reality (VR), augmented reality (AR), mixed reality (MR) or the like, a 3D display, or the like. The user terminal 200 may be carried by the user, or may be a system that is installed on site and used for exchanging information with users (for example, presenting information to users by a projector and acquiring information from the users by a sensor or voice, and the like). With these configurations, it is possible to provide the user of the user terminal 200 with a virtual space that mimics the real world, a virtual space that does not necessarily mimic the real world, a mixed reality space in which virtual is superimposed on the real world, or the like to. In addition, a U1 such as an avatar can be provided, so that it is possible to provide exchange of virtual space information with each other and efficient communication in real time.

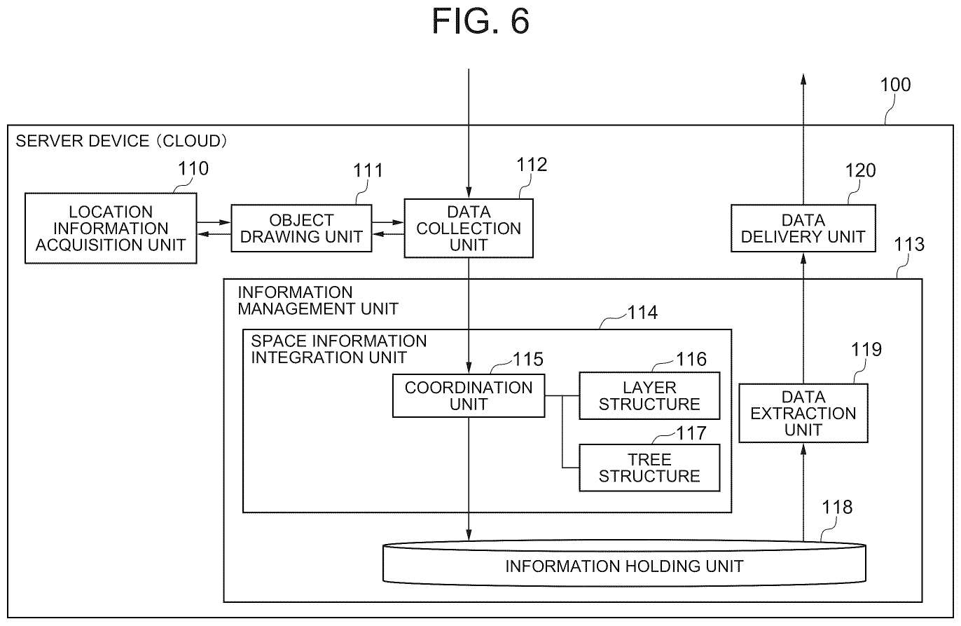

FIG. 6 illustrates a logical configuration example of the server device 100. The server device 100 includes a location information acquisition unit 110, an object drawing unit 111, a data collection unit 112, an information management unit 113, and a data delivery unit 120. The information management unit 113 include a space information integration unit 114, an information holding unit 118, and a data extraction unit 119. The information storage unit 118 corresponds to a database that holds virtual space information therein. Although the information holding unit 118 exists inside the server device 100 in FIG. 6, it may exist outside the server device 100. The space information integration unit 114 includes a coordination unit 115, a layer structure 116, and a tree structure 117.

The location information acquisition unit 110 acquires location information (space information, geographic information, and the like) of user terminals, parcels, and the like. The object drawing unit 111 creates, moves, deletes, updates, and the like of objects of users, persons, buildings, parcels, and the like. The data collection unit 112 collects virtual space information that is edited, integrated, or updated by the location information acquisition unit 110 and the object drawing unit 111, and the virtual space information transmitted from the user terminal 200. The coordination unit 115 of the space information integration unit 114 organizes the virtual space information collected by the data collection unit 112 in the layer structure 116 or the tree structure 117, and stores it in the information holding unit 118. That is, in the space information integration unit 114, for every information such as information acquired by the location information acquisition unit 110, information created by the object drawing unit 111, and information acquired from the user terminals 200, association and integration, coordination of the information granularity thereof, and the like are performed.

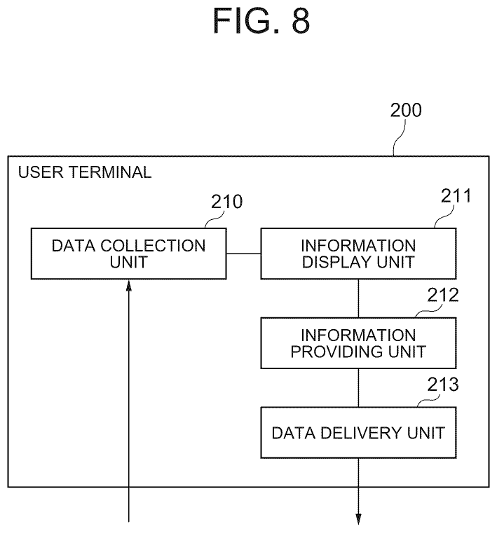

The data extraction unit 119 extracts, from the virtual space information stored in the information holding unit 118, necessary virtual space information (including record data) in accordance with a request received from each user terminal 200. The data delivery unit 120 transmits the virtual space information extracted by the data extraction unit 119 to the user terminal 200. In the user terminal 200, the virtual space information transmitted from the data delivery unit 120 is received by the data collection unit 210 illustrated in FIG. 8. The data extraction unit 119 extracts a part that each user terminal desires to confirm or a necessary part for making communication, from the information holding unit 118. Alternatively, the data extraction unit 119 extracts information of a part that each user desires to check or a part that each user desires to make communication in fine granularity (the degree of details of the information) from the information holding unit 118, and extracts information of a part not so necessary at that time in rough granularity from the information holding unit 118, and synthesizes them and transmits to the user terminal 200. As described above, it is possible to share necessary and useful information in real time without transmitting every large-amount data held in the information holding unit 118 as it is.

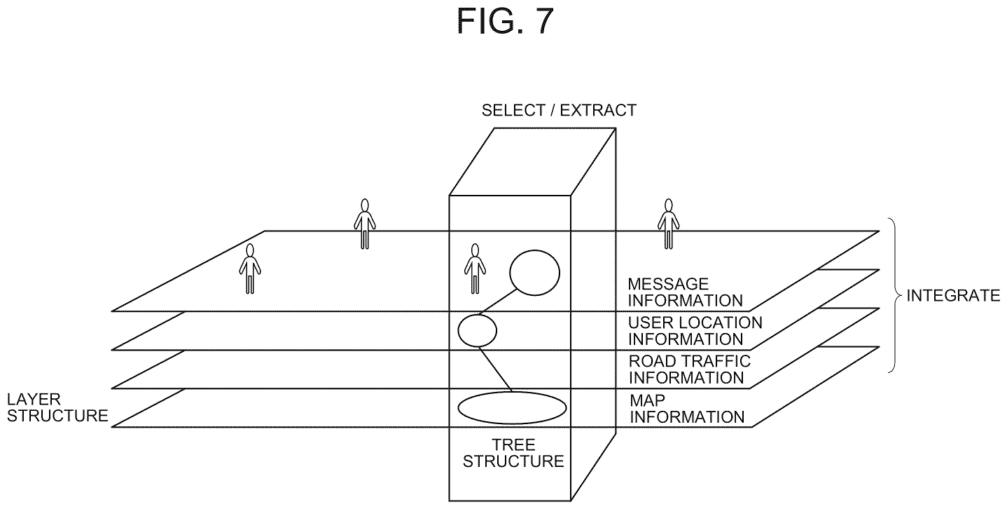

FIG. 7 is a schematic diagram illustrating a structure of extracting only data necessary for the user of a user terminal from the virtual space information stored in the information holding unit 118. For example, information such as map information, road traffic information, user location information, and message information (time information and location information, data of other various types of information, information of each organization, business type, task, user role, and the like) are entirely integrated as a layer structure, and the granularity is adjusted for each layer, and the information is stored in the information holding unit 118. Pieces of virtual space information stored in a plurality of layers are associated with each other (including temporal association) by a tree structure, a graph structure, or a network structure. The data extraction unit 119 selects, retrieves, or extracts, from data stored on a layer, necessary data related to such data stored on another layer via a tree structure or the like, to thereby be able to acquire data necessary for each user terminal integrally and efficiently. While it places a heavy load and takes time for integrating information in consideration of the association after extracting the pieces of information for the respective layers, in the case of the above-described method in which they are associated in advance, it is possible to make the load small and to secure real time property. In addition, with these systems, easy management (insertion, extraction, change, update, and the like) can be realized, and multiplexing of information spaces can also be made.

FIG. 8 illustrates a logical configuration example of the user terminal 200. Referring to FIG. 8, the user terminal 200 includes a data collection unit 210, an information display unit 211, an information providing unit 212, and a data delivery unit 213. The data collection unit 210 acquires virtual space information stored in the server device 100, from the server device 100. The information display unit 211 displays the virtual space information acquired by the data collection unit 210, on the display device of the user terminal 200. The information providing unit 212 provides new virtual space information. Note that the information display unit 211 may display the virtual space information newly provided by the information providing unit 212 on the display device. The information display unit 211 can express information acquired by the data collection unit 210 in the virtual space, and display it by using the avatar or the like of the user so as to be easily understandable, but the expression method is not limited thereto. The information providing unit 212 performs update and edit of the virtual space information acquired by the data collection unit 210, creation of information from other functions (camera, GPS, and the like) of the user terminal, original generation of information by the user, and the like, and can give original information to the information obtained from the server device 100. The data delivery unit 213 transmits such virtual space information to the server device 100 (or acquires from the server device 100). The server device 100 receives and stores the transmitted data.

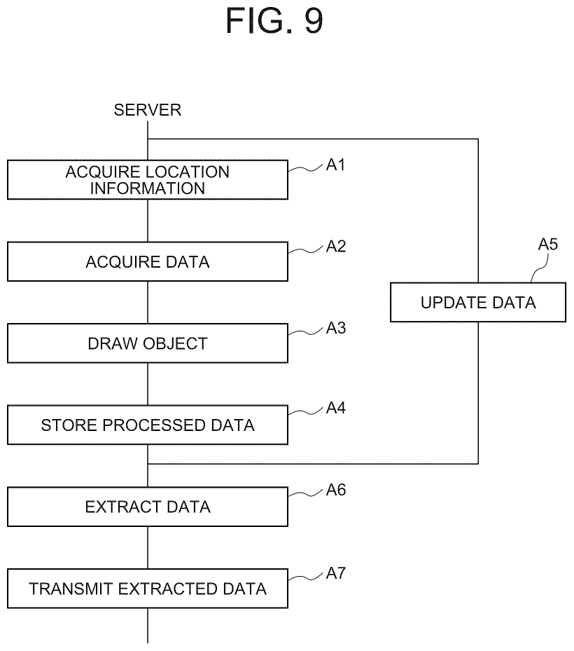

FIG. 9 is a flowchart illustrating an example of processing performed by the server device 100. Referring to FIG. 9, the location information acquisition unit 110 of the server device 100 acquires location information of objects such as users and parcels, space, and the like (step A1). The data collection unit 112 performs data acquisition (step A2). The object drawing unit 111 performs creation, moving, deletion, update, and the like of an object (step A3). The information management unit 113 stores the processing data in the information holding unit 118 (step A4). The information management unit 113 also performs update of the data stored in the information holding unit 118 (step A5). As a result, the virtual space information stored in the information holding unit 118 can always be displayed on the user terminal as real-time information. In addition, the data extraction unit 119 extracts data necessary for each user terminal from the virtual space information stored in the information holding unit 118, in accordance with a request from each user terminal 200 (or notification determination by the server device or another system) (step A6). The data delivery unit 120 transmits the virtual space information extracted by the data extraction unit 119 to each user terminal (step A7).

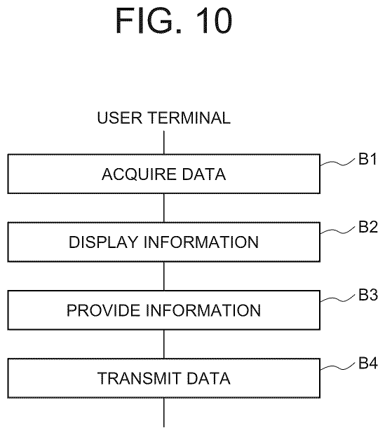

FIG. 10 is a flowchart showing an example of processing performed by the user terminal 200. The data collection unit 210 acquires virtual space information from the server device 100 (step B1). The information display unit 211 displays the virtual space information acquired by the data collection unit 210, on the display device (step B2). The information providing unit 212 provides information such as a message and the like according to an input operation by the user of the user terminal 200 (step B3). The data delivery unit 213 transmits the virtual space information to which the message or the like is provided, to the server device 100 (step B4).

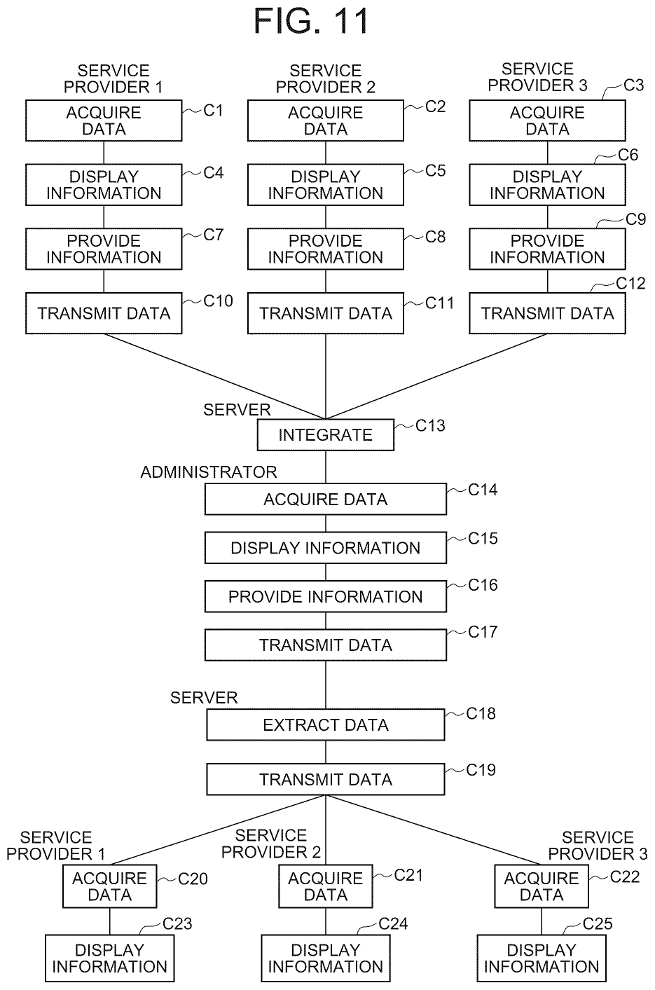

FIG. 11 is a flowchart illustrating an example of processing of the entire information processing system. In the user terminal 200 of a service provider (doctor), the data collection unit 210 acquires data (steps C1 to C3), the information display unit 211 displays the acquired information (steps C4 to C6), the information providing unit 212 further provides information (steps C7 to C9), and the data delivery unit 213 transmits the data to the server device 100 (steps C10 to C12). In the server device 100, the virtual space information received from the server device 100 is integrated (step C13), and the information is transmitted to the user terminal 200 of the administrator (paramedic).

In the user terminal 200 of the administrator, the data collection unit 210 acquires the virtual space information transmitted from the server device 100 (step C14), the information display unit 211 displays the information (step C15), the information providing unit 212 further provides information (step C16), and the data delivery unit 213 transmits the virtual space information after the information is provided, to the server device 100 (step C17).

In the server device 100, after the virtual space information transmitted from the user terminal 200 of the administrator is stored in the information holding unit 118, the data extraction unit 119 extracts necessary data from the virtual space information stored in the information holding unit 118 (step C18), and the data delivery unit 120 transmits the extracted virtual space information to the user terminal 200 of the service provider.

In the user terminal 200 of each of the service providers 1 to 3, the data collection unit 210 acquires the virtual space information transmitted from the server device 100 (steps C20 to C22), and the information display unit 211 displays the virtual space information on the display device (steps C23 to C25).

As described above, according to the present embodiment, when a paramedic finds the transport destination of a patient, it is possible to share information with doctors of the nearby hospitals in the virtual space in real time, and make contact more efficiently than the case of using telephone, which lead to quick transportation of a patient and elimination of labor shortage.

### Fourth Example Embodiment

Next, a fourth example embodiment of the present invention will be described. The present embodiment is an example of applying the present invention to a station facility.

To share information between administrators of station facilities, telephones and transceivers are used currently. Tasks of station staff include unlocking, roll call, handover, job assignment (ticket gate, platform monitoring, cleaning of station premises, administrative work), checking after the last train, locking, and others (meal staff, announcement of train arrival and delay, passenger guiding, commuter pass sales staff, signal staff capable of operating point machine in the premises, and the like). While there are various tasks of station staff, IT has not been introduced in guiding particularly. Therefore, it is necessary to rapidly introduce IT. Moreover, since a station master is in charge of a plurality of stations, it is also necessary to introduce IT to communication tools between stations. In a large station, there are problems that it is difficult to share locations of a person having a sudden illness and AED, locations of a suspicious object and a lost item, the place where must be cleaned, between administrators at remote places, and that when a person having a sudden illness appears, it takes time for arrival of an emergency service.

In view of the above, the information processing system according to the present embodiment schematically or abstractly shows the real station facility in a virtual space, and station staff members are reflected as avatars or the like in the virtual space. As a result, the present information processing system allows the station staff to understand the situation of the entire station premises in real time, and allows easy communication between the station staff members Thereby, the tasks of the station staff members can be carried out efficiently. Further, sharing of information between different stations can be also facilitated.

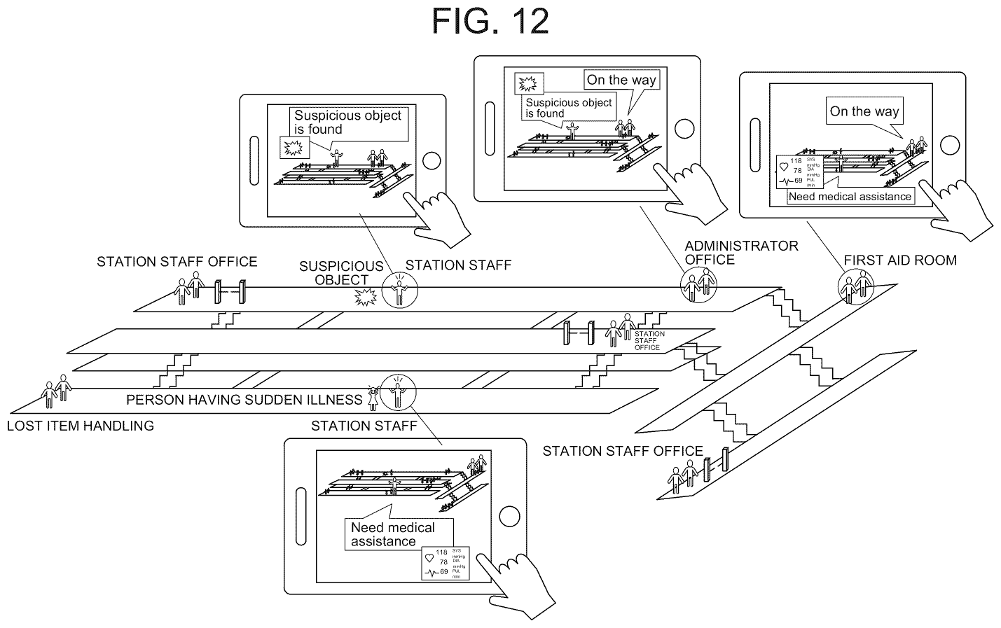

FIG. 12 is a schematic diagram illustrating an example of virtual space information shared between station staff members in the present information processing system. In this example, the station staff share virtual space information including map information of the station premises, user location information, location information of a passenger in trouble and suspicious object, and the like. When a station staff member finds a suspicious object and operates the own avatar existing in the virtual space shown on the user terminal to send a message “Suspicious object is found”, the server device that received this message displays the message on the user terminal of another station staff member staying at the administrator office. Here, the server device may interpret the meaning of the message and automatically determine the destination of the message to a station staff member in charge of handling suspicious objects staying at the administrator office. Further, when the station staff member staying at the administrator office operates the own avatar to send a message such as “On the way”, the server device that received the message sends such message to the user terminal of the station staff member who found the suspicious object. As described above, it is possible to share necessary virtual space information in real time among the station staff in charge of the same task.

On the other hand, in FIG. 12, when another station staff member finds a passenger who needs medical assistance, and operates the own avatar existing in the virtual space shown on the user terminal to send a message “Need medical assistance”, the server device that received this message displays the message on the user terminal of another station staff member staying at the first aid room. Here, the server device may interpret the meaning of the message and automatically determine the destination of the message to a station staff member in the first aid room. Further, when the station staff member in the first aid room operates the own avatar to send a message such as “On the way”, the server device that received the message sends such message to the user terminal of the station staff member who found the passenger who needs medical assistance. As described above, it is possible to share necessary virtual space information in real time among the station staff in charge of the same task.

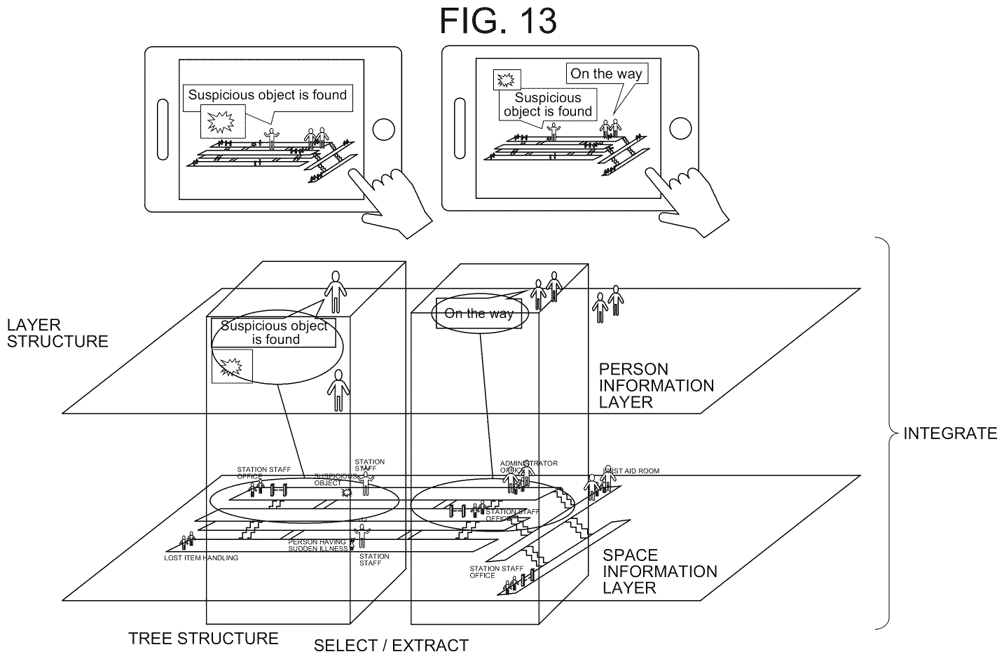

FIG. 13 illustrates an example of a structure of data extraction in a station facility.

Referring to FIG. 13, a database for storing virtual space information in the present embodiment is configured of various layers such as a person information layer including information of a passenger in trouble, information of station staff, information of first aid room, and information of administrator office, and the like, a space information layer including location information of users, a passenger in trouble, and a suspicious object, map of the station premises, and the like, and a time layer enabling confirmation of past records, and the virtual space information is multiplexed. As described above, the virtual space information is integrated as a layer structure, and it is possible to adjust the granularity for each layer. In addition, layers are linked by a tree structure or a graph structure and are managed in a multiplexed manner. The server device can select or extract data necessary for each user terminal from such virtual space information.

Furthermore, a user can add (multiples) any virtual layers, virtual information, and virtual structures. For example, in the case where a long delay occurs in a train due to a personal injury accident and it is necessary to announce travel time and alternate transportation, or in the case where there is a large-scale event in neighborhood and congestion is expected, it is possible to simulate the flow of people and where personnel must be allocated, on the virtual space.

As described above, according to the present embodiment, in sharing information among station staff members in charge of different tasks, and sharing with outside staff such as paramedics, cleaning staff, and security staff, it is possible to share only necessary information and not to share unnecessary information. Moreover, information can be shared in appropriate information granularity (the degree of details).

### Fifth Example Embodiment

Next, a fifth example embodiment of the present invention will be described. The present embodiment is an example of applying the present invention to logistics.

In the field of logistics, the load placed on the service provider is increasing due to wide spread of internet shopping, in addition to labor shortage. Therefore, more smooth logistics is expected in the future by elimination of labor shortage using autonomous cars based in roadside stations and the like, reduction of redelivery, and visualization of product information. In the current logistics, the number of relay points is large in a wide city and it takes time to reach.

Therefore, it is necessary to eliminate labor shortage and reduce redelivery by efficiently sharing information. In the future when autonomous cars are introduced, logistics using autonomous cars becomes the mainstream, and there is a possibility that the business form will be changed to that a large number of different service providers are involved in delivery by not only autonomous cars but also self-employed delivery persons using motorcycles and bicycles.

In view of the above, the information processing system according to the present embodiment schematically or abstractly shows the real world in a virtual space, and various types of delivery service providers are reflected as avatars or the like in the virtual space. As a result, in the present information processing system, situations of the various types of delivery service providers, traffic information in the way of delivery, and delivery destination information can be grasped in real time. In addition, the present information processing system manages various types of delivery service providers remotely in real time, optimally allocates parcels to be delivered to service providers, and provides environments in which it is possible to contact the user of the delivery destination when there is any trouble. This enables elimination of labor shortage in the field of logistics and reduction of redelivery.

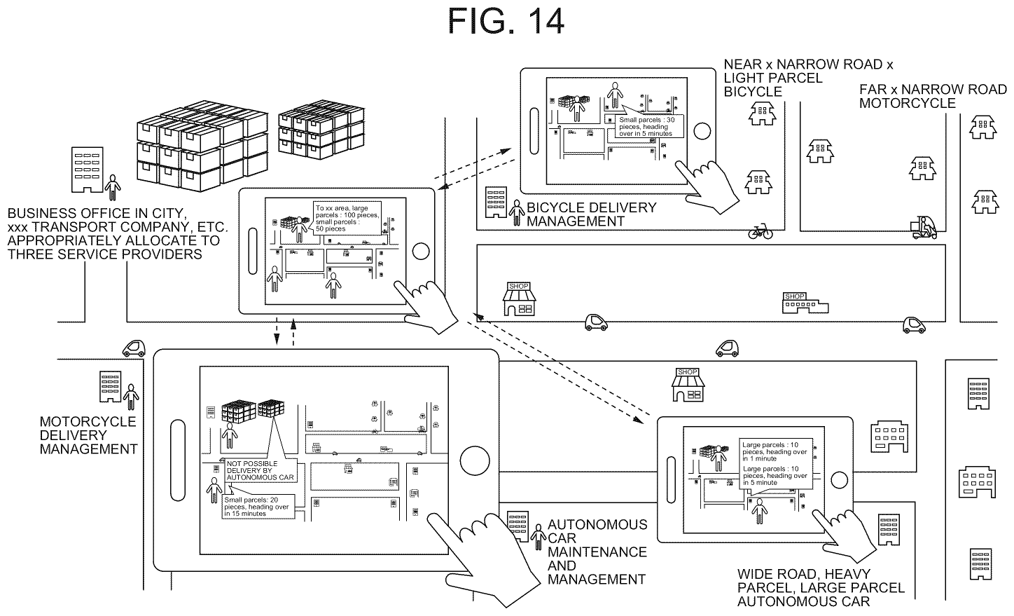

FIG. 14 is a schematic diagram illustrating an example of virtual space information shared between a delivery person manager and delivery persons in the present information processing system. In this example, a delivery person manager of a business office in a city and delivery persons of various types of delivery service providers share virtual space information including various types of information related to parcels to be delivered (size, delivery destination, and the like), location information of business offices and delivery service providers, city map information, transportation information, and the like. When a delivery person manager operates the own avatar existing in the virtual space shown on the user terminal to set various types of information related to parcels to be delivered, and send a message “To xx area, large parcels: 100 pieces, small parcels: 50 pieces”, the server device that received this message displays the message (not illustrated) on the user terminals of delivery persons of delivery service providers staying in the neighborhood. As a result, respective delivery persons in the neighborhood can recognize information related to the parcels to be delivered in real time. Then, when each delivery person determines parcels that he/she desires to accept and operates the own avatar to send a reply message such as “Small parcels 30 pieces, heading over in 5 minutes”, the server device that received the message sends the reply message to the user terminal of the delivery person manager.

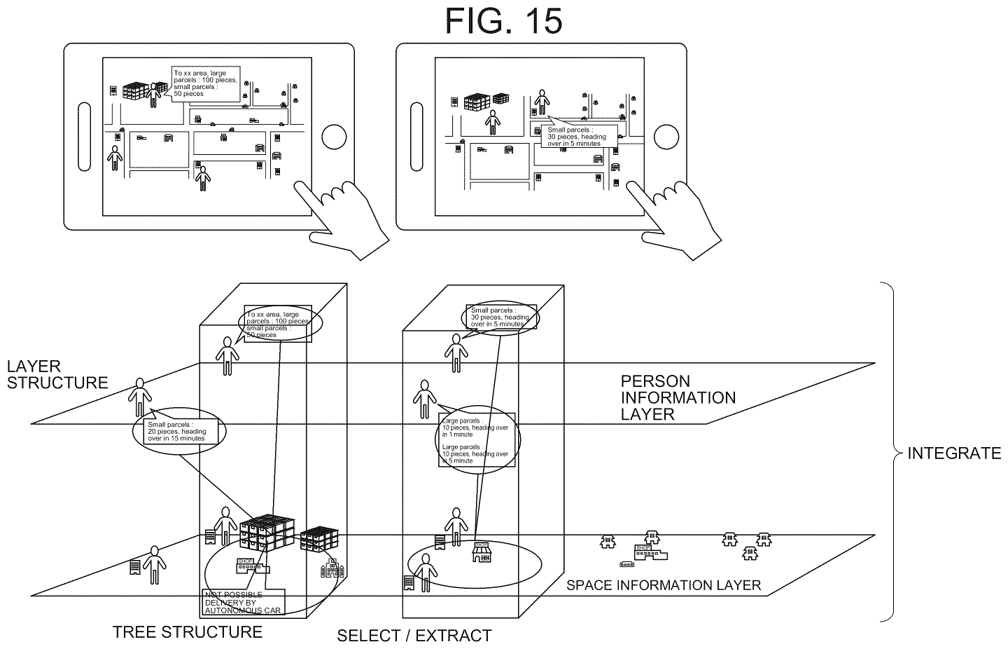

FIG. 15 illustrates an example of a structure of data extraction in logistics. Referring to FIG. 15, a database for storing virtual space information in the present embodiment is configured of various layers such as a person information layer including information of delivery persons using motorcycles and bicycles, information of business offices and a delivery person manager, and the like, a space information layer including location information of parcels, delivery persons, autonomous cars, the delivery person manager and the like, map, traffic information, and the like, and a time layer enabling confirmation of past records, and the virtual space information is multiplexed. The virtual space information as described above can be integrated as a layer structure, and the granularity thereof can be adjusted for each layer. In addition, the layers are linked by a tree structure or a graph structure, and are managed in a multiplexed manner. The server device selects or extracts data necessary for each user terminal from the virtual space information managed in such a manner. Furthermore, a user can add any virtual layers, virtual information, and virtual structures. For example, it is possible to place a person in charge of instruction in the virtual space and perform education or training of business offices, delivery persons, and delivery person managers, and to simulate movements of other delivery persons and the like, so that they can be used to the workplace.

As described above, according to the present embodiment, staff involved in different businesses such as delivery management, vehicle management, and the like can share information uniformly on the present system. Even in that case, it is possible to transmit and share necessary information according to the business involved and the scope of responsibility. Therefore, it is possible to carry out the own business efficiently.

### Sixth Example Embodiment

Next, a sixth example embodiment of the present invention will be described. The present embodiment is an example of applying the present invention to a logistics warehouse.

In a logistics warehouse, when a manager and a worker staying at remote places in the warehouse contact each other, telephone, email, or chat is used and data sharing is managed using spreadsheet software or the like. However, in that case, when the data is updated after completion of the work, a time lag occurs from the actual on-site situation. This causes unnecessary stock transfer and arrival. In addition, it is difficult to understand the on-site situation only with data as described above, and even though pictures and moving images are used, a person away from the site is hard to understand spatial and environmental situation of the site. Moreover, it is difficult to inform the site manager and the like of such a situation from the workers on site.

In view of the above, the information processing system according to the present embodiment schematically or abstractly shows the real logistics warehouse in a virtual space, and managers and workers are reflected as avatars or the like in the virtual space. In addition, the present information processing system handles information about the inside of the warehouse such as racks and parcels that is changed from time to time as objects and acquires the location information and the movement thereof in real time, and reflect them in the virtual space. Moreover, the present information processing system enables information sharing easily by allowing the manager and the workers to smoothly make communication remotely in real time via the avatars or the like.

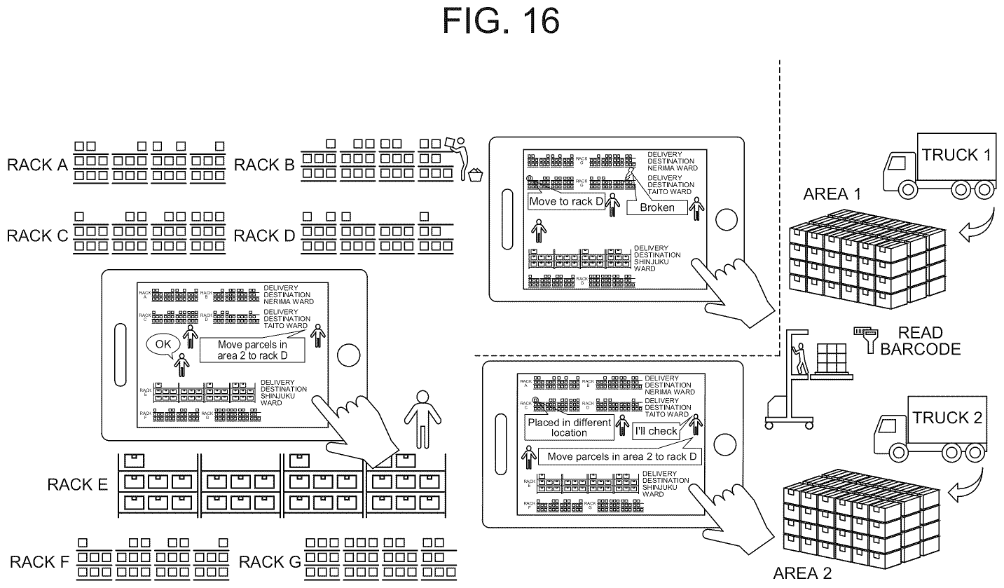

FIG. 16 is a schematic diagram illustrating an example of virtual space information shared between a manager and workers in the present information processing system. In this example, a manager and workers share virtual space information including map information of the inside of a logistics warehouse, user location information, location information of parcels stored on the racks, and the like. When a manager operates the own avatar existing in the virtual space shown on the user terminal to send a message “Move parcels in area 2 to rack D”, the server device that received this message displays the message on a user terminal of a worker staying near the manager. As described above, it is possible to make necessary communication in real time while sharing information such as location of the parcels on the racks between the manager and the worker.

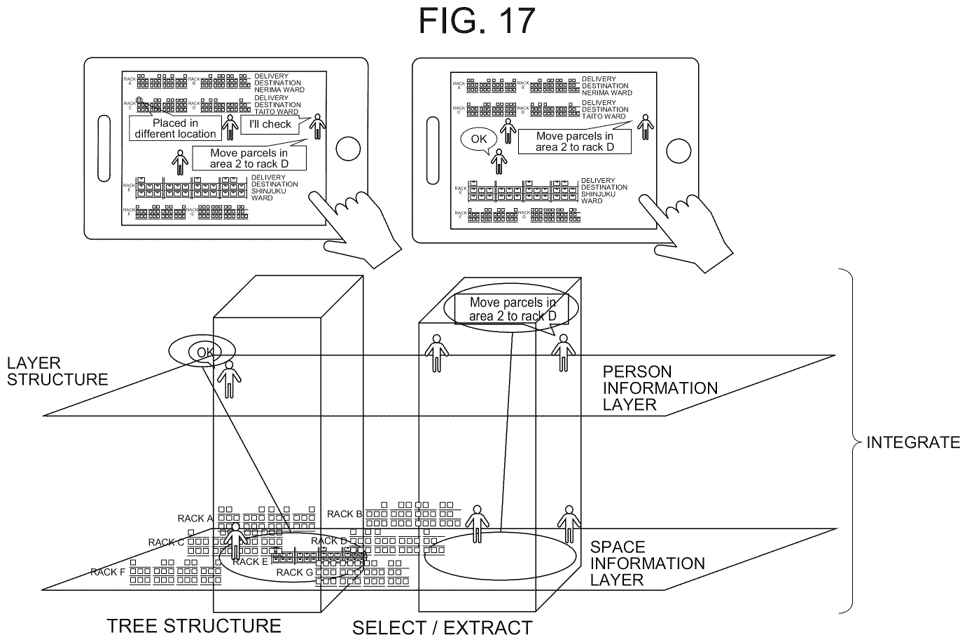

FIG. 17 illustrates an example of a structure of data extraction in a logistics warehouse. Referring to FIG. 17, a database for storing virtual space information in the present embodiment is configured of various layers such as a person information layer including information of a manager and workers in the warehouse, a space information layer including location information of parcels, workers, and a manager, warehouse map, and the like, and a time layer enabling confirmation of past records. The virtual space information is stored in a multiplexed manner. As described above, the virtual space information is integrated as a layer structure, and it is possible to adjust the granularity for each layer. In addition, the layers are linked by a tree structure or a graph structure and are managed in a multiplexed manner. The server device selects or extracts data necessary for each user terminal from such virtual space information. Furthermore, a user can add any virtual layers, virtual information, and virtual structures. For example, it is possible to use the present embodiment for instructing placement of virtual parcels at a correct location, simulating how to place parcels in a space-saving manner using virtual parcels, performing new employee training, and the like.

As described above, according to the present embodiment, information sharing and instruction can be made in the virtual space in real time between a manager and workers staying at remote locations. Therefore, location changes of parcels in the warehouse can be made easily. In addition, space saving, real-time sharing of working situation in remote locations, and time reduction of new employee training can also be made.

### Seventh Example Embodiment

Next, a seventh example embodiment of the present invention will be described. The present embodiment is an example of applying the present invention to maintenance and management of a tunnel or the like using a model in which Building/Construction Information Modeling Management (BIM/CIM) is visualized.

The information processing system according to the present embodiment schematically or abstractly shows structures (buildings, dams, tunnels, and the like) handled in the BIM/CIM, and reflects workers of maintenance and management, workers of plumbing work, workers of electrical work, and the like with avatars in the virtual space. Moreover, in the present information processing system, the workers share information from construction to maintenance and management in the virtual space. As a result, workers and managers can understand the situation of the entire place to be managed in real time. This makes communication easy, and allows the respective tasks to be performed efficiently. Moreover, this facilitate information sharing among the workers in charge of different tasks involved in the construction and management. Furthermore, not only real-time situation of the place but also past records can be confirmed retroactively.

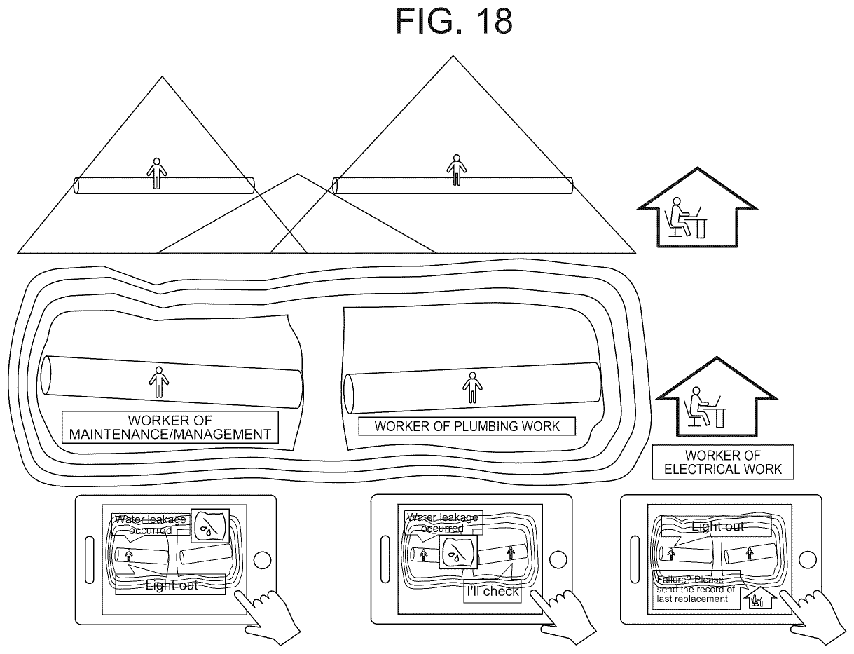

FIG. 18 is a schematic diagram illustrating an example of virtual space information in the present information processing system. In this example, a plurality of workers in charge of maintenance and management of a tunnel share virtual space information including tunnel structure information, user location information, problem occurring place and cause information, and the like. When a worker in charge of maintenance and management finds water leakage and light out, and operates the own avatar existing in the virtual space shown on the user terminal to send messages “Water leakage occurred” and “Light out”, the server device that received these messages displays the message “Water leakage occurred” on the user terminal of a worker in charge of plumbing work, and displays the message “Light out” on the user terminal of a worker in charge of electrical work. Here, the server device may interpret the meaning of the messages and automatically determine the destinations of the messages to a worker in charge of plumbing work and a worker in charge of electrical work as described above. Further, when the worker in charge of plumbing work operates the own avatar to send a message “I'll check” for example, the server device that received the message sends such message to the user terminal of the worker who found the water leakage. Further, when the worker in charge of electrical work operates the own avatar to send a message “Failure? Please send the record of last replacement” for example, the server device that received the message sends such message to the user terminal of the worker who found the light out.

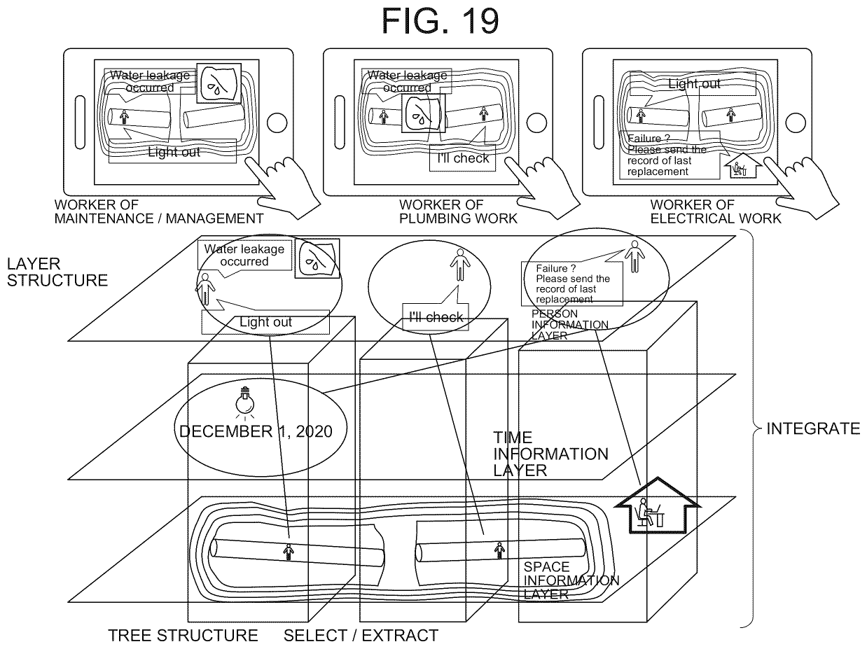

FIG. 19 illustrates an example of data extraction in maintenance and management of a tunnel or the like using the BIM/CIM visualization model. Referring to FIG. 19, a database for storing virtual space information in the present embodiment is configured of various layers such as a person information layer including information about workers in charge of maintenance and management, workers of plumbing work, workers of electrical work, and the like, a time layer for retroactively checking past records, a space information layer including location information of workers and working places using the BIM/CIM model, and the like. The virtual space information is stored in a multiplexed manner. As described above, the virtual space information is integrated as a layer structure, and it is possible to adjust the granularity for each layer. In addition, the layers are linked by a tree structure or a graph structure and are managed in a multiplexed manner. The server device selects or extracts data necessary for each user terminal from such virtual space information. Furthermore, a user can add any virtual layers, virtual information, and virtual structures. For example, simulation can be made by overlapping a virtual completion image such as a BIM/CIM visualization mode on the real world by using MR/AR glasses.

While the present invention has been described with reference to the example embodiments described above, the present invention is not limited to the above-described embodiments. The form and details of the present invention can be changed within the scope of the present invention in various manners that can be understood by those skilled in the art.

For example, instead of the CPU, the information processing device may use a Graphic Processing Unit (GPU), a Digital Signal Processor (DSP), a Micro Processing Unit (MPU), a Floating number Processing Unit (FPU), a Physics Processing Unit (PPU), a Tensor Processing Unit (TPU), a quantum processor, a microcontroller, or a combination thereof.

The present invention is based upon and claims the benefit of priority from Japanese patent application No. 2022-051679, filed on Mar. 28, 2022, the disclosure of which is incorporated herein in its entirety by reference.

### INDUSTRIAL APPLICABILITY

The present invention can be utilized in scenes of recording, display, and instruction in real time in a situation that changes from time to time in a vast space such as building maintenance and inspection and monitoring of factories, plants, infrastructure facilities, operation assisting purposes, scenes where the same content is reviewed remotely on a real-time basis, and the like. In addition, the present invention is applicable to operation monitoring in a transportation system, a logistics system, and the like, management of facilities such as buildings and real estates, operation and management of event sites, and the like.

The whole or part of the example embodiments disclosed above can be described as, but not limited to, the following supplementary notes.

### Supplementary Note 1

An information processing system comprising a plurality of user terminals and a server device connected with the user terminals, and allowing the user terminals to share virtual space information, the information processing system further comprising a database having a layer structure including layers for respective types of the virtual space information and configured to store the virtual space information in the layer structure, wherein the server device is configured to, for each of the user terminals, extract virtual space information necessary for a user of the user terminal from the database, and transmit the virtual space information to the user terminal.

### Supplementary Note 2

The information processing system according to supplementary note 1, wherein the database is configured to associate units of virtual space information that are related to each other and stored on a plurality of layers, with each other by a tree structure, a graph structure, or a network structure.

### Supplementary Note 3

The information processing system according to supplementary note 1 or 2, wherein the user terminal is configured to process the virtual space information according to a user operation, and transmit the virtual space information to the server device, and the server device is configured to receive the virtual space information from the user terminal, and store the received virtual space information on a layer of the database corresponding to a type of the received virtual space information.

### Supplementary Note 4

The information processing system according to any of supplementary notes 1 to 3, wherein the layer structure is configured to include a layer for an organization, a business type, a task, or a role of a user of the user terminal.

### Supplementary Note 5

The information processing device according to supplementary note 4, wherein the database is configured to associate units of the virtual space information that are related to each other and stored on a plurality of the layers for different organizations, business types, tasks, or roles, with each other by a tree structure, a graph structure, or a network structure.

### Supplementary Note 6

A server device in an information processing system, the information processing system including a plurality of user terminals and the server device connected with the user terminals and allowing the user terminals to share virtual space information, the server device comprising a database having a layer structure including layers for respective types of the virtual space information, and configured to store the virtual space information in the layer structure, wherein the server device is configured to, for each of the user terminals, extract virtual space information necessary for a user of the user terminal from the database, and transmit the virtual space information to the user terminal.

### Supplementary Note 7

The server device according to supplementary note 6, wherein the database is configured to associate units of virtual space information that are stored and related to each other, with each other by a tree structure, a graph structure, or a network structure.

### Supplementary Note 8

The server device according to supplementary note 6 or 7, wherein the server device is further configured to receive the virtual space information from the user terminal that is configured to process the virtual space information according to a user operation and transmit to the server device, and store the received virtual space information on a layer of the database corresponding to a type of the received virtual space information.

### Supplementary Note 9

The server device according to any of supplementary notes 6 to 8, wherein the layer structure is configured to include a layer for an organization, a business type, a task, or a role of a user of the user terminal.

### Supplementary Note 10

The server device according to supplementary note 9, wherein the database is configured to associate units of the virtual space information that are related to each other and stored on a plurality of the layers for different organizations, business types, tasks, or roles, with each other by a tree structure, a graph structure, or a network structure.

### Supplementary Note 11

An information processing method to be executed by a server device in an information processing system, the information processing system including a plurality of user terminals and the server device connected with the user terminals and allowing the user terminals to share virtual space information, the method comprising, from a virtual space information database having a layer structure including layers for respective types of the virtual space information and configured to store the virtual space information in the layer structure, for each of the user terminals, extracting virtual space information necessary for a user of the user terminal, and transmitting the virtual space information to the user terminal.

### Supplementary Note 12

A program for causing a computer constituting a server device in an information processing system to execute processing to, the information processing system including a plurality of user terminals and the server device connected with the user terminals and allowing the user terminals to share virtual space information, from a virtual space information database having a layer structure including layers for respective types of the virtual space information and configured to store the virtual space information in the layer structure, for each of the user terminals, extract virtual space information necessary for a user of the user terminal, and transmit the virtual space information to the user terminal.

### REFERENCE SIGNS LIST

1 information processing system
2 server device
3 database
4 user terminal
5 network

What is claimed is:

1-3. (canceled)

4. A server device in an information processing system, the information processing system including a plurality of user terminals and the server device connected with the user terminals and allowing the user terminals to share virtual space information, the server device comprising:
a database having a layer structure including layers for respective types of the virtual space information, and configured to store the virtual space information in the layer structure;
a memory containing program instructions; and
a processor coupled to the memory, wherein the processor is configured to execute the program instructions to,
for each of the user terminals, extract virtual space information necessary for a user of the user terminal from the database, and transmit the virtual space information to the user terminal.

5. The server device according to claim 4, wherein
the database is configured to associate units of virtual space information that are stored and related to each other, with each other by a tree structure, a graph structure, or a network structure.

6. The server device according to claim 4, wherein the processor is further configured to execute the instructions to
receive the virtual space information from the user terminal that is configured to process the virtual space information according to a user operation and transmit to the server device, and store the received virtual space information on a layer of the database corresponding to a type of the received virtual space information.

7. The server device according to claim 4, wherein
the layer structure is configured to include a layer for an organization, a business type, a task, or a role of a user of the user terminal.

8. The server device according to claim 7, wherein
the database is configured to associate units of the virtual space information that are related to each other and stored on a plurality of the layers for different organizations, business types, tasks, or roles, with each other by a tree structure, a graph structure, or a network structure.

9. An information processing method to be executed by a server device in an information processing system, the information processing system including a plurality of user terminals and the server device connected with the user terminals and allowing the user terminals to share virtual space information, the method comprising,
from a virtual space information database having a layer structure including layers for respective types of the virtual space information and configured to store the virtual space information in the layer structure, for each of the user terminals, extracting virtual space information necessary for a user of the user terminal, and transmitting the virtual space information to the user terminal.

10. A non-transitory computer-readable medium storing thereon a program comprising instructions for causing a computer constituting a server device in an information processing system to execute processing to, the information processing system including a plurality of user terminals and the server device connected with the user terminals and allowing the user terminals to share virtual space information,
from a virtual space information database having a layer structure including layers for respective types of the virtual space information and configured to store the virtual space information in the layer structure, for each of the user terminals, extract virtual space information necessary for a user of the user terminal, and transmit the virtual space information to the user terminal.
